(19) United States
(12) Patent Application Publication
(10) Pub. No.: US 2006/0043284 A1
(43) Pub. Date: Mar. 2, 2006

(54) Micro chip, liquid feeding method using the micro chip, and mass analyzing system

(75) Inventors: Masakazu Baba, Tokyo (JP); Toru Sano, Tokyo (JP); Kazuhiro Iida, Tokyo (JP); Hisao Kawaura, Tokyo (JP); Noriyuki Iguchi, Tokyo (JP); Wataru Hattori, Tokyo (JP); Hiroko Someya, Tokyo (JP); Minoru Asogawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 10/536,407

(22) PCT Filed: Nov. 28, 2003
(86) PCT No.: PCT/JP03/15255

§ 371 Date: May 26, 2005

(30) Foreign Application Priority Data
Nov. 29, 2002 (JP) 2002-349251

(51) Int. Cl. B01D 59/44

(52) U.S. Cl. 250/288; 250/284

(57) ABSTRACT

A sample reservoir (205) in which a sample (213) is introduced is sealed by a septum (207). On piercing the septum (207) by an injection needle, the sample reservoir (205) is communicated with the outer atmosphere, and then the sample (213) is delivered from the channel 203 to the water absorbing portion (209).

### BACKGROUND OF THE INVENTION

1. Field of the Invention

This invention relates to a microchip as well as a liquid delivery method and a mass spectrometry system therewith

2. Description of the Related Art

Proteomics has got a lot of attention as a promising research method in a post-genome age. In a proteomics study, a sample such as a protein is identified by, for example, mass spectrometry as a final stage. Prior to the stage, a sample is separated and pretreated for mass spectrometry, for example. As a method for such sample separation, two-dimensional electrophoresis has been widely used. In two-dimensional electrophoresis, amphoteric electrolytes such as a peptide and a protein are separated at their isoelectric points and then further separated according to their molecular weights.

However, these separation methods generally require as much time as a whole day and night. Furthermore, they give a lower sample recovery and thus a relatively smaller amount of sample for analysis such as mass spectrometry. There has been, therefore, needs for improvement in this respect.

Micro-chemical analysis (μ-TAS) has been rapidly progressed, where chemical operations for a sample such as pretreatment, reactions, separation and detection are conducted on a microchip. A separation and analysis procedure utilizing a microchip can reduce the amount of a sample to be used and thus environmental loading, allowing for analysis with higher sensitivity. It may significantly reduce a time for separation.

However, for flowing a liquid in a channel, a system must have, in addition to a microchip, separate liquid-delivery means such as a liquid-delivery pump, which makes it difficult to reduce a device size. In particular, when disposing a plurality of channels in a microchip, each channel requires liquid-delivery means, leading to a larger size of an overall apparatus. Furthermore, a liquid flow rate to a channel tends to fluctuate due to pulsation in a liquid-delivery pump.

Thus, there has been suggested that a liquid delivery member is formed on a microchip (Patent literature 1). However, in this technique, delivery of a sample is started concurrently with injection of the sample into an inlet, and the sample is fed to a liquid absorber. Therefore, the sample cannot be retain in the inlet, initiation or stopping of delivery from the inlet cannot be controlled, or a flow rate cannot be controlled.

Patent literature 1: Japanese Patent Application No. 2001-88096

### SUMMARY OF THE INVENTION

In view of the problem, an objective of this invention is to provide a microchip whereby timing of liquid delivery to a channel can be conveniently controlled. Another objective of this invention is to provide a microchip for stably feeding a liquid to a channel at a constant rate. A further objective of this invention is to provide a method for stably delivering a liquid to a channel at a constant rate. Another objective of this invention is to provide a mass spectrometry system applicable to a biological sample.

This invention provides a microchip comprising a substrate, a channel formed on the substrate and a sample drying area having a fine channel communicated with the channel, wherein as a liquid in the sample drying area is evaporated, a liquid in the channel moves to the sample drying area.

This invention also provides a method for delivering a liquid in the microchip as described above, comprising: introducing a liquid into the channel; introducing a liquid into the sample drying area; evaporating the liquid introduced into the sample drying area while moving the liquid in the channel to the sample drying area. Herein, the liquids introduced into the channel and the sample drying area may have different compositions or the same composition. Since a drying rate of the sample liquid depends on the properties of the liquid introduced into the drying member, a solvent immiscible with the sample liquid introduced into the channel can be introduced into the drying member to control the drying rate independently of the sample liquid. This approach is effective in case that variation in a sample concentration during sample drying is undesirable.

In this invention, the sample drying area communicated with the channel is formed, so that the liquid in the sample drying area can be evaporated to move the liquid in the channel toward the sample drying area. The sample drying area having such a configuration can be easily fabricated because it can be integrally formed with the channel. The liquid can be efficiently delivered only using the microchip without an external drying apparatus.

This invention also provides a microchip comprising a substrate, a channel formed on the substrate and a sample drying area having a fine channel communicated with the channel, wherein during evaporation of the liquid in the sample drying area, the liquid is retained in the sample drying area and at the end of sample drying, the liquid retained in the sample drying area moves toward the channel.

This invention also provides a method for delivering a liquid in the microchip as described above, comprising: introducing a liquid into the sample drying area; evaporating the liquid introduced into the sample drying area; stopping evaporation of the liquid to move the liquid toward the channel.

In this invention, during the liquid is evaporated in the sample drying area, the sample is retained in the sample drying area, and at the end of stopping evaporation, the liquid is fed to the channel, so that timing of transferring the liquid into the channel can be appropriately adjusted. Thus, forming such a sample drying area on a microchip allows a given reaction to be effected in predetermined timing.

In the microchip according to this invention, the sample drying area may comprise a plurality of pillars. The pillars may be formed in the bottom surface of the sample drying area or in a surface other than the bottom surface. A plurality of pillars can be formed in the sample drying area to increase a surface area in a liquid-contacting surface in the sample drying area to the volume of the sample drying area (hereinafter, also referred to as “specific surface area”). Thus, evaporation of the liquid in the sample drying area can be further accelerated. Furthermore, by forming the pillars, the liquid channel in the sample drying area becomes fine channels, so that a liquid suction force to the sample drying area by capillary phenomenon can be increased. Thus, the liquid can be efficiently sucked.

In this invention, “fine channels” may be specifically:
(i) spaces between a plurality of protrusions formed in the drying member or filling members such as beads;
(ii) pores in a porous material disposed in the drying member; or
(iii) concaves formed in the channel wall.
   The fine channels are preferably communicated with an opening. Thus, a sample suction path from the channel through the fine channels to the opening can be ensured, resulting in reliable suction/drying.

The microchip according to this invention may comprise a temperature controlling member for controlling a temperature of the sample drying area. Thus, an evaporation rate of a liquid in the sample drying area can be controlled to precisely adjust a delivery measure. Thus, fluctuation of a delivery measure can be minimized to stably suck or deliver a liquid at a constant rate. Furthermore, since the sample drying area is formed on the microchip, the temperature controlling member can be easily fabricated by forming a resistor or a thermoelectric device using semiconductor processing.

This invention also provides a microchip comprising a substrate, a channel formed on the substrate, a sealed liquid retaining member communicated with the channel and a water absorbing portion communicated with the channel, wherein the liquid retaining member comprises a switch member for unsealing the liquid retaining member, wherein on unsealing, a liquid in the liquid retaining member moves to the water absorbing portion through the channel.

This invention also provides a method for delivering a liquid in the microchip as described above, comprising: introducing the liquid into the liquid retaining member; unsealing the liquid retaining member to move the liquid to the channel.

According to this invention, the liquid retaining member is sealed, so that the liquid is not introduced into the channel until the member is unsealed by the switch member. Timing of introducing the liquid into the channel can be, therefore, easily controlled. Furthermore, since such a liquid retaining member can be formed on a substrate together with the channel, it can be easily formed, eliminating the necessity of an external liquid delivery apparatus. Furthermore, the amount of the liquid in the liquid retaining member is introduced into the channel, so that a given amount of liquid can be introduced into the channel.

In the microchip according to this invention, the water absorbing portion may comprise an opening. Thus, by unsealing the liquid retaining member, the member is communicated with the outer atmosphere through the openings in the liquid retaining member and in the water absorbing portion, so that the liquid in the liquid retaining member can be quickly delivered into the channel.

The microchip of this invention may have a configuration where the liquid retaining member comprises a lid and the switch member is a pin formed in the lid, and the pin can be broken to open the lid for unsealing the liquid retaining member.

This invention also provides a method for delivering a liquid in the microchip as described above, comprising: introducing a liquid into the liquid retaining member; and unsealing the liquid retaining member to move the liquid to the channel, wherein the step of unsealing comprises the step of opening the lid by breaking the pin.

Thus, by breaking the pin, the liquid retaining member is communicated with the outer atmosphere to initiate liquid delivery, so that timing of liquid delivery can be easily adjusted. Since the pin can be integrally formed with the lid, it can be easily fabricated.

This invention also provides a microchip comprising a substrate, a channel formed on the substrate and a liquid retaining member communicated with the channel, wherein the liquid retaining member is sealed by a septum.

This invention also provides a method for delivering a liquid in the microchip, comprising: piercing the septum by an injection needle, through which the liquid is then introduced into the liquid retaining member; pulling out the injection needle from the septum to reseal the liquid retaining member; and piercing the septum by a hollow needle member to unseal the liquid retaining member for moving the liquid to the channel.

According to this invention, since the liquid retaining member is sealed by the septum, the septum may be pierced by, for example, an injection needle to easily inject a liquid into the liquid retaining member. Herein, after injecting the liquid, the septum can close on drawing out the injection needle, so that the injected liquid can be retained in the liquid retaining member. Then, the septum can be pierced by the hollow needle member in given timing, to conveniently unseal the liquid retaining member for initiating liquid delivery to the channel. Thus, both filling of the liquid retaining member with the liquid and timing of liquid delivery can be controlled, resulting in a microchip whereby liquid delivery can be satisfactorily controlled.

In the microchip according to this invention, the upper surface of the liquid retaining member can be covered by a lid with a septum. Thus, the microchip can be easily formed by forming a hole in the lid and inserting, for example, a plug type septum in the hole.

This invention also provides a microchip comprising a substrate, a channel formed on the substrate and a liquid retaining member communicated with the channel, wherein the liquid retaining member comprises a liquid retention area and a damming part intervening between the liquid retention area and the channel and comprising a lyophobic surface to the liquid; and in the liquid retaining member, a moving member comprising a lyophilic surface to the liquid is disposed movably from a position other than the damming part to the damming part.

In the microchip according to this invention, the liquid retaining member comprises the damming part, so that a given amount of the liquid filling the liquid retention area is retained in the liquid retention area. Then, as the moving member moves to the damming part, water adhering to the moving member acts as priming water to feed the liquid retained in the liquid retention area into the channel. Thus, timing of introducing the liquid into the channel can be easily controlled. Furthermore, since such a liquid retaining member can be formed on a substrate together with the channel, it can be easily formed, eliminating the necessity of an external liquid delivery apparatus. Furthermore, the amount of the liquid in the liquid retaining member is introduced into the channel, so that a given amount of liquid can be introduced into the channel.

The microchip of this invention may have a configuration where the liquid retaining member or the channel comprises a liquid-sucking portion communicated with the damming part and an air-introducing member communicated with the liquid-sucking portion.

This invention also provides a method for delivering a liquid in the microchip as described above, comprising: introducing the liquid into the liquid retaining member; and moving the moving member to the damming part to introduce the liquid adhering to the moving member surface into the liquid-sucking portion.

Thus, when the moving member is moved to the damming part, the liquid adhering to the moving member becomes in contact with the liquid-sucking portion while the liquid retained in the liquid retention area is introduced into the liquid-sucking portion by a suction force of the liquid-sucking portion. Thus, timing of liquid delivery can be satisfactorily controlled. Furthermore, since the air-introducing member communicated with the liquid-sucking portion is formed, the sample liquid in the channel can be dammed in the air-introducing member. Thus, when the liquid is introduced in the liquid-sucking portion, the liquid sample in the channel is moved in the channel under pressure. Herein, since the air in the air-introducing member separates the liquid introduced into the liquid retaining member from the sample liquid in the channel, only the liquid sample can be efficiently moved in the channel under pressure.

In the liquid delivery method according to this invention, the step of moving the moving member to the damming part may comprise the step of magnetically moving the moving member. Thus, using a magnetic moving member, a position of the moving member can be easily controlled with a magnet. Timing of liquid delivery can be, therefore, easily controlled.

This invention also provides a mass spectrometry system comprising separation means for separating a biological sample according to a molecular size or properties; pretreatment means for pretreating the sample separated by the separation means including enzymatic digestion; drying means for drying the pretreated sample; and mass spectrometry means for analyzing the dried sample by mass spectrometry, wherein at least one of the separation means, the pretreatment means and the drying means comprises any of the microchips described above. Herein, the biological sample may be extracted from an organism or synthesized.

As described above, this invention can provide a microchip in which timing of liquid delivery to a channel can be conveniently controlled. Furthermore, this invention can provide a microchip in which a given amount of liquid can be stably delivered to a channel. This invention also provides a method for delivering a liquid whereby a given amount of liquid can be stably delivered to a channel. This invention also provides a mass spectrometry system applicable to a biological sample.

### BRIEF DESCRIPTION OF THE DRAWINGS

The above and other objectives, features and advantages will be more clearly understood with reference to embodiments described below and the accompanied drawings.

FIG. 1 is a plan view showing an illustrative configuration of a microchip according to this invention.

FIG. 2 shows an area around a sucking portion in the microchip in FIG. 1.

FIG. 3 illustrates filling the microchip in FIG. 1 with a liquid.

FIG. 4 is a cross-sectional view illustrating operation of the sucking portion in the microchip in FIG. 1.

FIG. 5 is a plan view showing an illustrative configuration of a microchip according to this invention.

FIG. 6 shows an illustrative configuration of a microchip according to this invention.

FIG. 7 shows operation of the microchip in FIG. 6.

FIG. 8 illustrates a method for filling the microchip in FIG. 5 with a sample and a method for feeding a sample under pressure.

FIG. 9 is a plan view showing an illustrative configuration of a microchip according to this invention.

FIG. 10 is a plan view showing an illustrative configuration of a microchip according to this invention.

FIG. 11 shows operation of the microchip in FIG. 10.

FIG. 12 is a process cross-sectional view illustrating a process for manufacturing a microchip according to this embodiment.

FIG. 13 is a process cross-sectional view illustrating a process for manufacturing a microchip according to this embodiment.

FIG. 14 is a process cross-sectional view illustrating a process for manufacturing a microchip according to this embodiment.

FIG. 15 schematically shows a configuration of a mass spectrometer.

FIG. 16 is a block diagram of a mass spectrometry system comprising a microchip according to this embodiment.

FIG. 17 shows an illustrative configuration of a microchip according to this invention.

FIG. 18 schematically shows a configuration of a microchip according to Example.

FIG. 19 shows a configuration of pillars formed in a sucking portion in a microchip according to Example.

FIG. 20 shows exuding of a DNA in a sucking portion in a microchip according to Example.

FIG. 21 shows a channel outlet for a microchip according to Example having a sucking portion with no pillars.

### DETAILED DESCRIPTION OF THE INVENTION

Specific configurations of this invention will be described with reference to the drawings. In all the figures, similar elements are indicated by the same symbols, for which description is not represented as appropriate.

(First Embodiment)

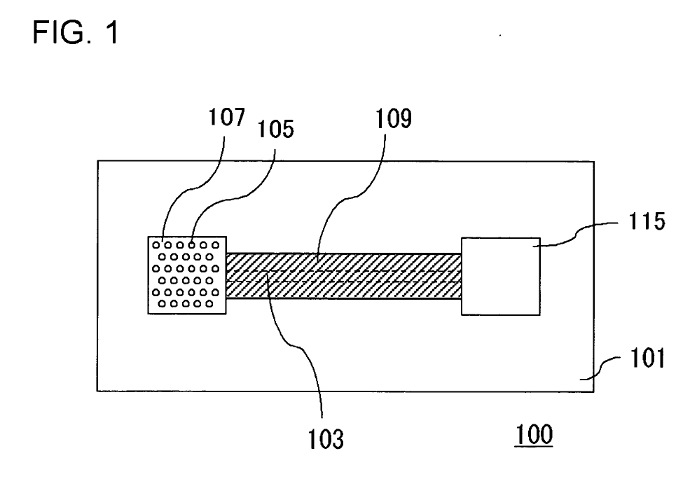

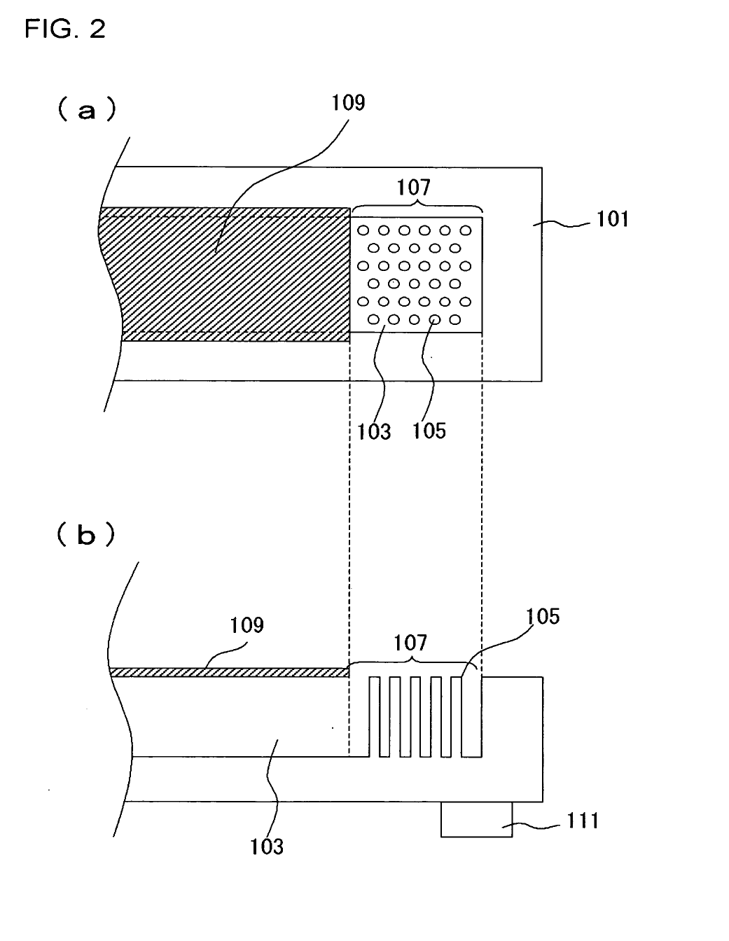

This embodiment relates to a microchip feeding a sample liquid to a channel by retaining the sample liquid utilizing a suction force generated by evaporating a solvent in the sample liquid by drying and stopping the drying in predetermined timing. FIG. 1 is a plan view showing a configuration of a microchip 100 according to this embodiment. FIG. 2 shows an area around a sucking portion in the microchip in FIG. 1. As shown in FIGS. 1 and 2, in the microchip 100, the substrate 101 comprises a channel 103 which in one end has a sucking portion 107 comprising a number of pillars 105 and in the other end has a sample recovering portion 115. A cover 109 covers the channel 103, but not the sucking portion 107, forming an opening. A temperature of the bottom of the sucking portion 107 can be controlled by a heater 111.

Since the microchip 100 comprises the sucking portion 107 capable of controlling retention and discharge of a liquid, the liquid is not delivered to the sample recovering portion 115 during suction of the liquid in the sucking portion 107 and at the end of suction in the sucking portion 107, the liquid is fed to the sample recovering portion 115.

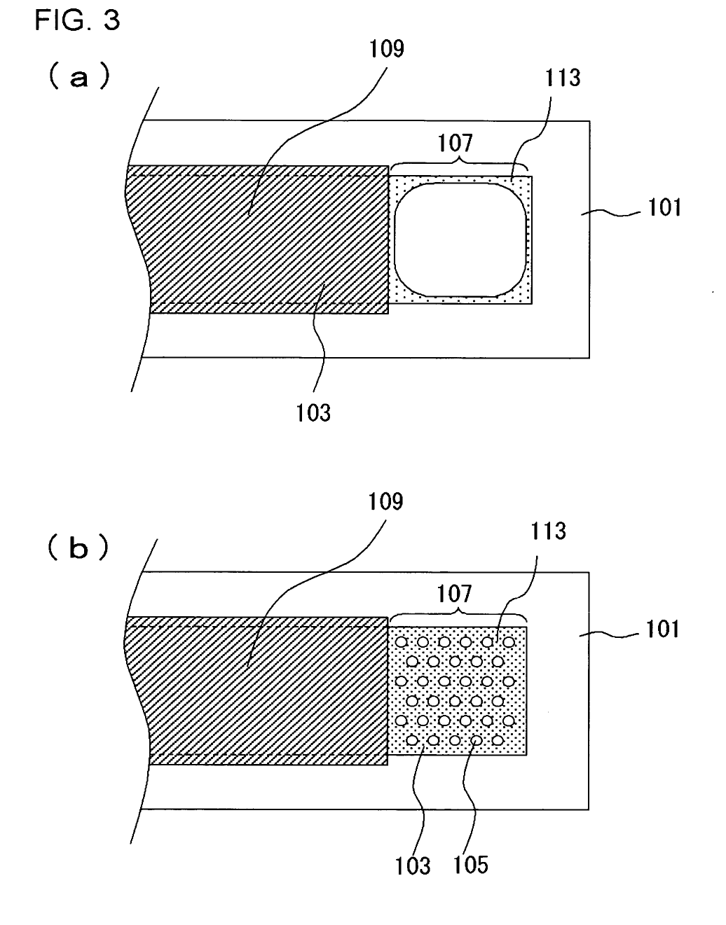

FIG. 3 illustrates filling of the microchip 100 in FIG. 1 with the liquid. Since in the microchip 100, the sucking portion 107 has a number of pillars 105, the liquid is introduced such that the liquid wets the whole channel wall of the sucking portion 107. It will be described with reference to FIG. 3. FIG. 3(a) shows a configuration in which the sucking portion 107 has no pillars 105, while FIG. 3(b) shows the configuration of this embodiment. As shown in FIG. 3(a), without pillars 105, a liquid 113 can wet the sucking portion 107 only in an area along the channel wall from the edge of the cover 109. On the other hand, in FIG. 3(b), the pillars 105 are formed so that a liquid 113 is introduced from the channel 103 to the sucking portion 107 by capillary action and fills the whole area of the sucking portion 107. Therefore, in the configuration of FIG. 3(b), the whole upper surface of the sucking portion 107 can be covered with the liquid 113. Furthermore, since the pillars 105 are formed, a specific surface area of the channel wall in the sucking portion 107, that is, a wall surface area to a volume of the sucking portion 107, is adequately ensured. Having such a configuration, the microchip 100 exhibits a higher suction efficiency. Therefore, although the liquid 113 can be sucked to some extent without the pillars 105 in the sucking portion 107, it is preferable that the pillars 105 are formed for more stable suction or when a depth of the sucking portion 107 is, for example, smaller than 20 μm.

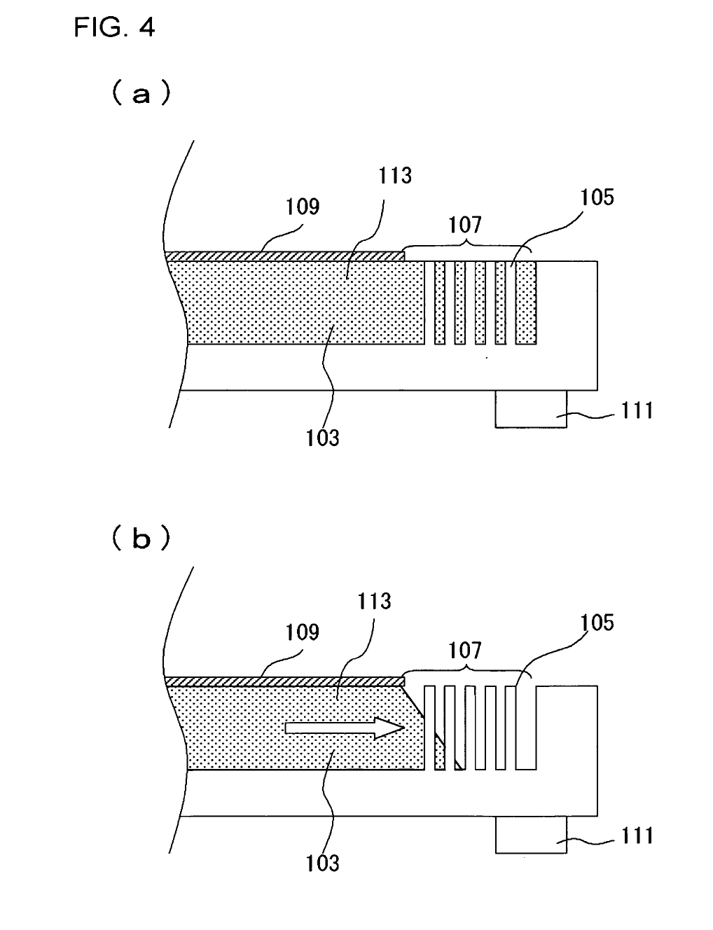

Next, with reference to FIG. 4, there will be described suction and discharge of the liquid 113, that is, liquid delivery to the sample recovering portion 115, in the sucking portion 107. FIG. 4 is a cross-sectional view for illustrating operation of the sucking portion 107 in the microchip 100 of FIG. 1. In the microchip 100, a sample liquid is fed from the channel 103 into the sucking portion 107 by capillary action (FIG. 4(a)), and then heated by a heater 111. Thus, the liquid 113 is evaporated on the upper surface of the sucking portion 107 at a suitable rate (FIG. 4(b)). Herein, in the configuration of FIG. 4(b), the pillars 105 are formed on the channel 103 in the sucking portion 107, so that a specific surface area of the channel wall in the sucking portion 107 is increased and thus the liquid 113 is rapidly moved to the upper surface, resulting in efficient suction of the liquid 113 in the sucking portion 107. The liquid 113 is continuously fed and sucked from the channel 103 to the sucking portion 107. Therefore, during heating by the heater 111, the liquid 113 in the channel 103 is sucked toward the sucking portion 107, but not moved toward the sample recovering portion 115. Herein, a heating temperature of the sucking portion 107 by the heater 111 can be appropriately selected, depending on some factors such as heat resistance of the substrate 101 and properties of the components contained in the sucked liquid 113. There are no particular restrictions as long as a heating rate of the solvent can be adequately controlled, for example, about 50 to 70 ° C. Alternatively, a drying rate of the sample liquid in the sucking portion 107 can be appropriately selected, depending on the components in the liquid 113 and treatment conditions in the channel 103; for example, 0.1 μl/min to 10 μl/min both inclusive, more specifically, 1 μl/min. Since a drying rate of the sample liquid depends on the properties of the liquid introduced into the sucking portion 107, a solvent immiscible with the liquid 113 filling the channel 103 can be introduced into the sucking portion 107 to control a drying rate independently of the sample liquid. The approach is effective in case that variation in a sample concentration during sample drying is undesirable.

In the sucking portion 107, the liquid 113 is sucked into the sucking portion 107 during heating by the heater 111 as described above. Furthermore, at the end of heating by the heater 111, the liquid 113 in the channel 103 is not sucked toward the sucking portion 107, but moves toward the sample recovering portion 115. Thus, in the microchip 100, the heater 111 acts as a switch for suction of the liquid 113. Liquid delivery to the sample recovering portion 115 can be controlled by ON/OFF of the heater 111. The microchip 100 can be integrally formed on the substrate 101 with the channel 103. Forming of the microchip 100 can eliminate the necessity of an external apparatus for liquid delivery as conventionally used. Thus, the microchip 100 can be integrally formed in a microchip, resulting in significant size reduction of the overall apparatus.

In the microchip 100, the cover 109 can be formed in any manner as long as it covers the substrate 101 while at least part of the upper part of the sucking portion 107 is opened. Since the cover 109 can seal the inside of the channel 103, the sample liquid in the channel 103 can be more efficiently introduced into the sucking portion 107. Furthermore, a size of the opening can be adjusted to control a drying rate of the liquid 113 in the sucking portion 107.

Next, there will be described materials for the microchip 100 and a manufacturing process therefor. The substrate 101 is made of silicon. The silicon surface is preferably oxidized. Thus, the substrate surface becomes hydrophilic, so that a sample channel can be suitably formed. Alternatively, the substrate 101 may be made of another material such as a glass including quartz and a plastic. Examples of a plastic include thermoplastic resins such as silicon resins, PMMA (polymethylmethacrylate), PET (polyethyleneterephthalate) and PC (polycarbonate) and thermosetting resins such as epoxy resins. Such a material can be easily shaped, resulting in reduction in a manufacturing cost for the microchip 100.

Alternatively, the substrate 101 may be made of a metal. Using a metal, temperature sensitivity of the sucking portion 107 can be improved to more precisely effect suction and discharge of the liquid 113 in response to ON/OFF of the heater 111.

The pillars 105 may be, for example, formed by, but not limited to, etching the substrate 101 in a predetermined pattern.

The pillars 105 in FIG. 1 is cylindrical, but they may be, in addition to a cylinder or pseudo-cylinder, a cone such as circular cone and elliptic cone; a prism such as trigonal prism and quadratic prism; and pillars having another cross-sectional shape. When the pillar 105 has a cross-sectional shape other than a pseudo-circle, the pillar 105 may have an irregular side, resulting in further increasing a surface area of the side and further improving a liquid absorbing force by capillary phenomenon.

Alternatively, a slit having the cross-section in FIG. 2(a) may be employed in place of the pillar 105. When using a slit, the pillar 105 may have any of various shapes such as a striped protrusion. Again, when using a slit, the side of the slit may be irregular to further increase a surface area of the side.

In terms of the dimensions of the pillar 105, a width may be, for example, about 15 nm to 100 μm. A distance between adjacent pillars 105 maybe, for example, 5 nm to 10 μm. In terms of its height, although it is at the substantially same level as the cover 109 in FIG. 1, it may protrude from the cover 109 or may be lower than the cover 109. When the pillars 105 protrude from the cover 109, a surface area of the pillars 105 may be increased to improve a suction efficiency in the sucking portion 107.

The cover 109 may be, for example, made of a material selected from those for the substrate 101. The material may or may not be the same as that for the substrate 101.

Next, a manufacturing process for the microchip 100 will be described. The channel 103 or the pillars 105 may be formed on the substrate 101 by, but not limited to, etching the substrate 101 into a predetermined pattern.

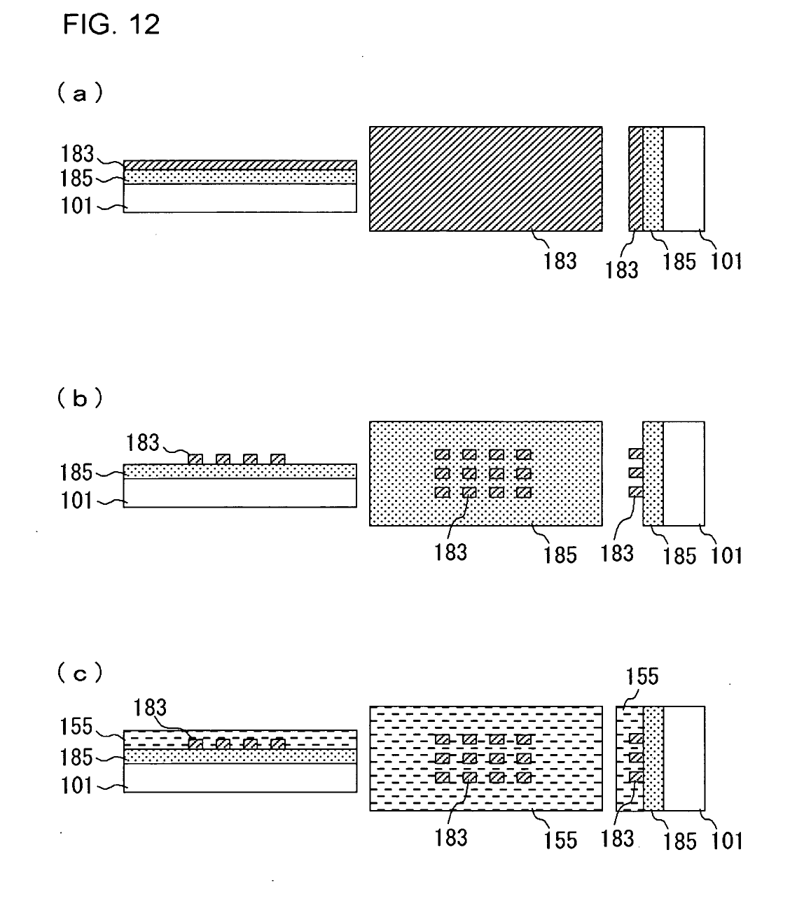

FIGS. 12, 13 and 14 are process cross-sectional views illustrating an exemplary manufacturing process. In sub-figures in each figure, the middle is a cross-sectional view and the right and the left are cross-sectional views. In this process, the pillars 105 are formed by the use of electron beam lithography using a calixarene as a resist for fine processing. The following is an exemplary molecular structure of a calixarene. A calixarene is used as a resist for electron beam exposure and may be suitably used as a resist for nano processing.

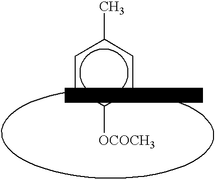

Herein, a substrate 101 is a silicon substrate with an orientation of (100). First, as shown in FIG. 12(a), on the substrate 101 are formed a silicon oxide film 185 and a calixarene electron-beam negative resist 183 in sequence. Thicknesses of the silicon oxide film 185 and the calixarene electron-beam negative resist 183 are 40 and 55 nm, respectively. Then, an area to be pillars 105 is exposed to an electron beam (EB). The product is developed with xylene and rinsed with isopropyl alcohol. By this step, the calixarene electron-beam negative resist 183 is patterned as shown in FIG. 12(b).

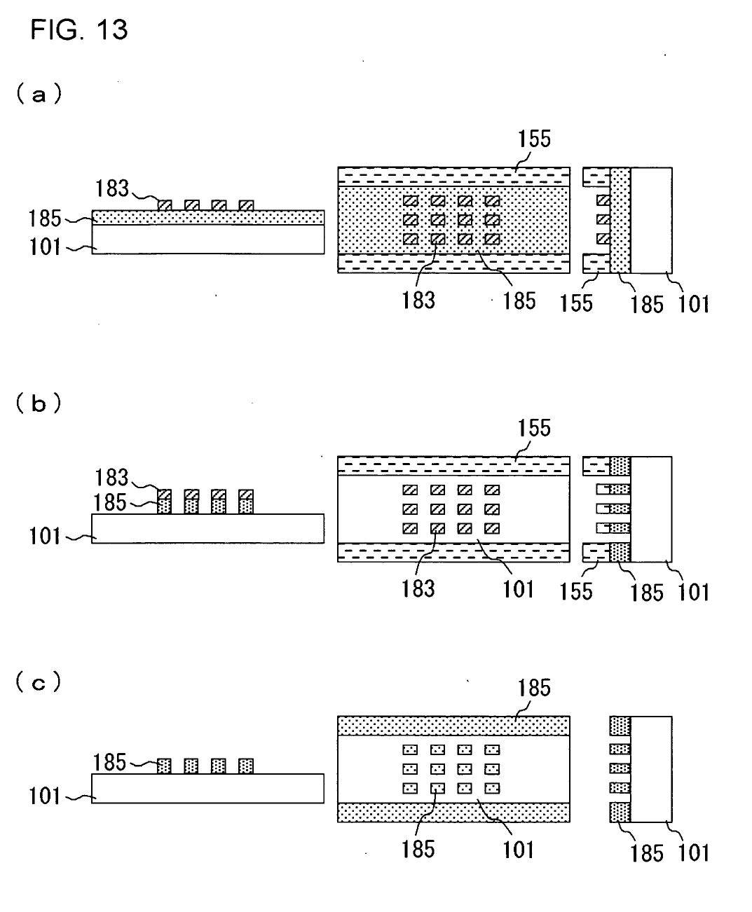

Next, a positive photoresist 155 is applied to the whole surface (FIG. 12(c)). Its thickness is 1.8 μm. Then, the product is developed by mask exposure such that the area to be the channels 103 is exposed (FIG. 13(a)).

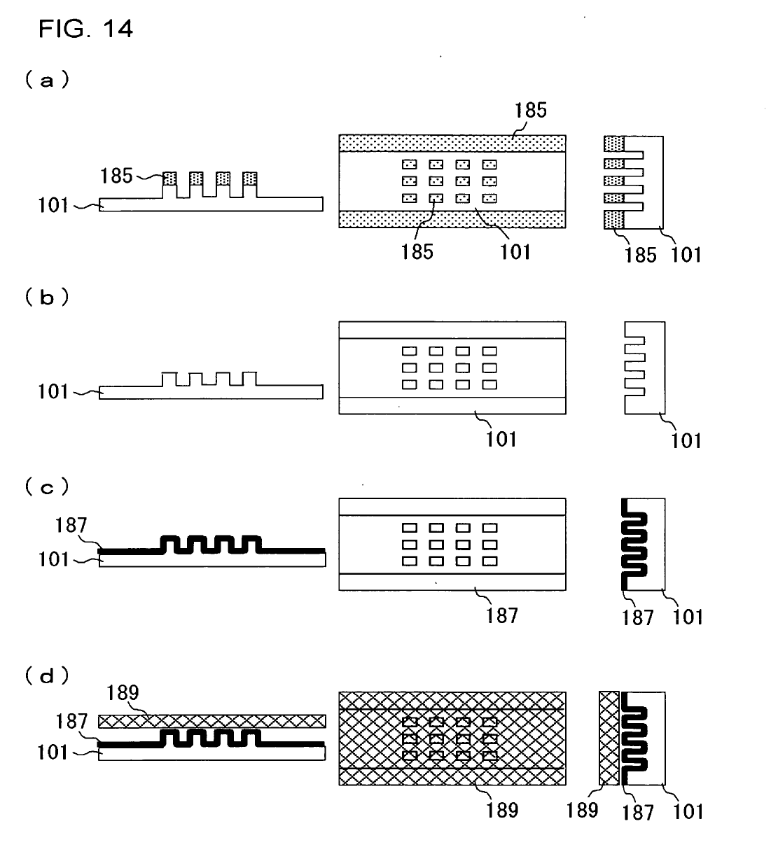

Then, the silicon oxide film 185 is RIE-etched using a mixed gas of CF₄ and CHF₃ to a thickness of 40 nm after etching (FIG. 13(b)). After removing the resist by washing with an organic solvent mixture of acetone, an alcohol and water, the substrate 101 is subjected to oxidation plasma treatment (FIG. 13(c)). Then, the substrate 101 is ECR-etched using HBr gas. A height of the step in the substrate 101 after etching is 400 nm (FIG. 14(a)). Next, the substrate 101 is wet etched with BHF (buffered hydrofluoric acid) to remove the silicon oxide film (FIG. 14(b)). Thus, the channel 103 and the pillars 105 are formed on the substrate 101.

Herein, it is preferable to make the surface of the substrate 101 hydrophilic after the step in FIG. 14(b). By making the surface of the substrate 101 hydrophilic, a sample liquid can be smoothly guided into the channel 103 and the pillars 105. In particular, in the sucking portion 107 where the channel is finer by the pillars 105, hydrophilization of the channel surface is preferable because it may promote introduction of a sample liquid by capillary acts to improve a drying efficiency.

After the step in FIG. 14(b), the substrate 101 is heated in a furnace to form a silicon thermal oxide film 187 (FIG. 14(c)). Herein, heating conditions are selected such that a thickness of the oxide film becomes 30 nm. Forming the silicon thermal oxide film 187 can eliminate difficulty in introducing a liquid into a separating device. Then, a cover 189 is electrostatically joined. After sealing, a microchip 100 is formed (FIG. 14(d)).

A metal film may be formed on the surface of the substrate 101. The metal film may be made of a material such as Ag, Au, Pt, Al and Ti. It may be deposited by, for example, vapor deposition or plating such as electroless plating.

When using a plastic material for the substrate 101, a known method suitable for the type of the material for the substrate 101 may be employed, including etching, press molding using a mold such as emboss molding, injection molding and photo-curing.

Again, when using a plastic material for the substrate 101, the surface of the substrate 101 is preferably hydrophilized. By hydrophilizing the surface of the substrate 101, a sample liquid can be smoothly introduced into the channel 103 and the pillars 105. In particular, in the sucking portion 107 where the channel 103 is finer by the pillars 105, hydrophilization of the surface of the channel 103 is preferable because it may promote introduction of a sample liquid by capillary phenomenon to improve a drying efficiency.

Surface treatment for hydrophilization may be, for example, conducted by applying a coupling agent having a hydrophilic group to the side wall of the channel 103. A coupling agent having a hydrophilic group may be a silane coupling agent having an amino group; for example N-β (aminoethyl) γ-aminopropylmethyldimethoxysilane, N-β (aminoethyl) γ-aminopropyltrimethoxysilane, N-β (aminoethyl) γ-aminopropyltriethoxysilane, γ-aminopropyltrimethoxysilane, γ-aminopropyltriethoxysilane and N-phenyl-γ-aminopropyltrimethoxysilane. These coupling agents may be applied by an appropriate method such as spin coating, spraying, dipping and vapor deposition.

After processing the substrate 101 as described above, a heater 111 for controlling a temperature of the sucking portion 107 is provided on the bottom of the substrate 101. By disposing the heater 111 such that the end of the sucking portion 107 is selectively heated, the microchip 100 can have a function of switching between suction and discharge of the liquid 113 in the channel 103 in the sucking portion 107.

In the microchip 100, the sucking portion 107 may comprise a water absorbing portion in place of the pillars 105. The water absorbing portion is a porous material having a relatively hydrophilic surface, and a sample is introduced from the channel 103 to the water absorbing portion disposed in the sucking portion 107 by capillary action. As used in this embodiment, the term “porous material” refers to a structure having a fine channel communicated with the outside in both sides.

The water absorbing portion may have any shape where a sample liquid can be introduced from the channel 103 to the sucking portion 107 by capillary action and evaporated on the surface. The water absorbing portion may be, for example, porous silicon, porous alumina, an etched concave structure formed by lithography or a water absorptive gel.

Alternatively, the sucking portion 107 may be comprised of beads filled therein. The beads are fine particles having a relatively hydrophilic surface. A sample solution is introduced from the channel 103 to the beads filling the sucking portion 107 by capillary action.

The configuration can be provided by forming the channel 103 in the surface of the substrate 101 and then filling one end of the surface with the beads. Herein, since the upper part of the channel 103 is opened, the configuration can be easily provided, because the beads can be smoothly placed. The beads may be made of any material whose surface is relatively hydrophilic. In case of a hydrophobic material, its surface may be hydrophilized. Examples of the material include inorganic materials such as glasses and various organic and inorganic polymers. The beads may have any shape which, when being placed, allows a channel for water to be ensured; for example, particles, needles or plates. For example, the beads as spherical particles may have an average particle size of 10 nm to 20 μm both inclusive.

The channel 103 can be filled with beads, for example, as follows. Before joining the cover 109, a mixture of beads, a binder and water is fed into the channel 103. Herein, a damming member is provided in the channel 103 to prevent the mixture from flowing outside the area to be the sucking portion 107. Then, the mixture can be evaporated to dryness to form the sucking portion 107. A binder may be, for example, a sol containing a water-absorbing polymer such as agarose gel and polyacrylamide gel. A sol containing such a water-absorbing polymer can be used to eliminate the need of drying because of spontaneous gelation. Alternatively, the sucking portion 107 may be formed by filling the channel groove with a suspension of the beads in water without a binder and drying it under the atmosphere of dry nitrogen gas or dry argon gas.

Alternatively, the sucking portion 107 may be formed by filling a dry water-absorbing polymer material. Herein, the surface of the substrate 101 is covered by a thick photoresist film whose exposed part can be eluted. Then, it is exposed using a photomask, by which an area in which the water-absorbing polymer is to be deposited is selectively exposed, and developed. Thus, the area in the surface of the substrate 101 where the polymer is to be deposited can be exposed.

Then, on the substrate 101 is spin-coated a fluid prepared by wetting a water-absorbing polymer such as carboxymethylcellulose and methylcellulose with water, and the substrate is adequately dried by, for example, a baking furnace. Subsequently, the resist is removed with an organic solvent such as acetone. Thus, only the water-absorbing polymer in the dried/solidified area in the exposed surface of the substrate 101 remains in the surface of the substrate 101 while the water-absorbing polymer coating on the resist is removed. The substrate 100 can be further dried to provide the substrate 101 where the dry water-absorbing polymer is provided in a desired area in the surface of the substrate 101.

(Second Embodiment)

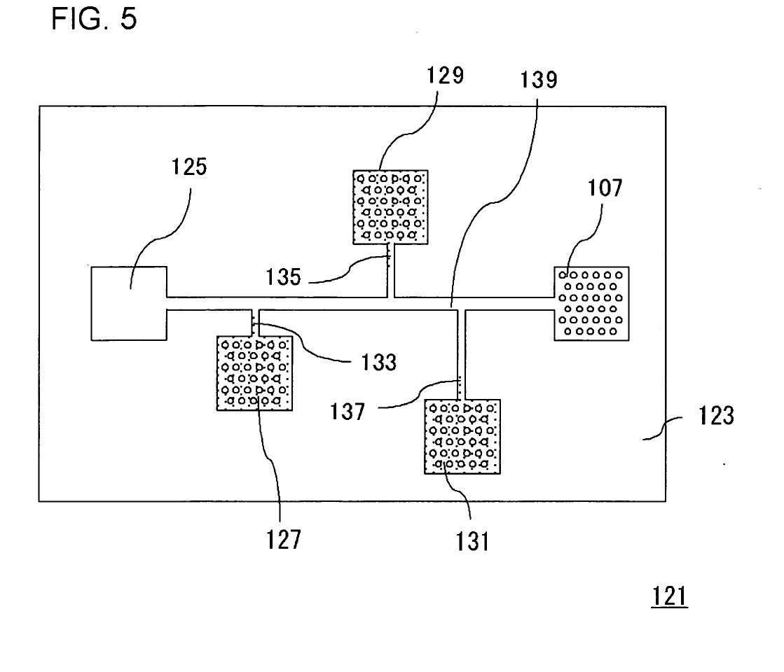

This embodiment relates to a microchip comprising a plurality of sucking portions, wherein a sample liquid introduced into a main channel is moved at a constant flow rate in the channel by a suction force generated by solvent evaporation while a reagent is retained by a suction force generated by solvent removal in a reagent solution in sub-channels by drying, and drying is stopped in predetermined timing to introduce the reagent into the main channel. FIG. 5 is a top view showing a configuration of a microchip 121 according to this embodiment. In the microchip 121, the sample introducing portion 125 is communicated with a sucking portion 107 via a main channel 139. The ends of three sub-channels 133, 135 and 137 branching from the main channel 139 are communicated with three sucking portions 127, 129 and 131, respectively. The sample introducing portion 125 is for introducing a sample. Within the sub-channels 133, 135 and 137, heaters (not shown) are operated for introducing different reagents from the sucking portions 127, 129 and 131, respectively, and for heating the sucking portions 127, 129 and 131, respectively. Thus, each reagent is retained in each sub-channel without entering the main channel 139.

On introducing a sample into the sample introducing portion 125, the sample flows in the main channel 139, during which a heater (not shown) for heating the sucking portion 107 can be operated to increase a flow rate of the sample. Heating in the sucking portion 127 is stopped slightly before the sample entering into the main channel 139 from the sample introducing portion 125 reaches the junction between the main channel 139 and the sub-channel 133. Then, the reagent in the sub-channel 133 flows from the sub-channel 133 toward the main channel 139 and mixed with a sample flowing in the main channel 139. These flows in the main channel 139 toward the sucking portion 107. In a similar manner, heating in the sucking portion 129 or 131 can be stopped slightly before the junction between the main channel 139 and the sub-channel 135 or the sub-channel 137, to introduce the reagent retained in the sub-channel 135 or the sub-channel 137 into the main channel 139 for being mixed with the sample.

Thus, by providing the microchip 121 with a plurality of sucking portions, a sample can be continuously treated by a variety of reactions or processes. Here, a separating portion for separating components in a sample based on their sizes, a specific interaction or the like can be appropriately disposed downstream of the sub-channel 137 in the main channel 139, allowing a desired process such as desalting to be effected after a reaction of the sample with the reagent.

Furthermore, since the sample introducing portion 125 is communicated with the sucking portion 107 in the microchip 121, a moving speed in the sample introducing portion 125 in the channel 103 can be controlled and the sample introduced into the sucking portion 107 can be heated by a heater (not shown) disposed in the sucking portion 107 for being collected as a dried sample. Thus, since not only continuous processing of a sample but also a series of processes to collection as a dried matter can be effected on one microchip, a small amount of a sample can be efficiently processed and collected.

Therefore, when the sample introduced into the sample introducing portion 125 is a protein, it can be, for obtaining detail data, subjected to appropriate treatments such as reduction of a disulfide bond and molecular-weight reduction to about 1000 Da by trypsin in the main channel 139 and a matrix material for MALDI-TOFMS is retained in the sucking portion 131, to finally introduce a mixture of the size-reduced sample and the matrix into the sucking portion 107. Then, after drying the sample 107 in the sucking portion 107, the microchip 121 can be placed in a vacuum chamber in the MALDI-TOFMS apparatus and used as a sample stage for MALDI-TOFMS. Herein, ametal film which is connectable to an external power source can be formed on the surface of the sucking portion 107, allowing a potential to be applied to it as a sample stage and thus the sample ionized by laser irradiation can travel in MALDI-TOFMS.

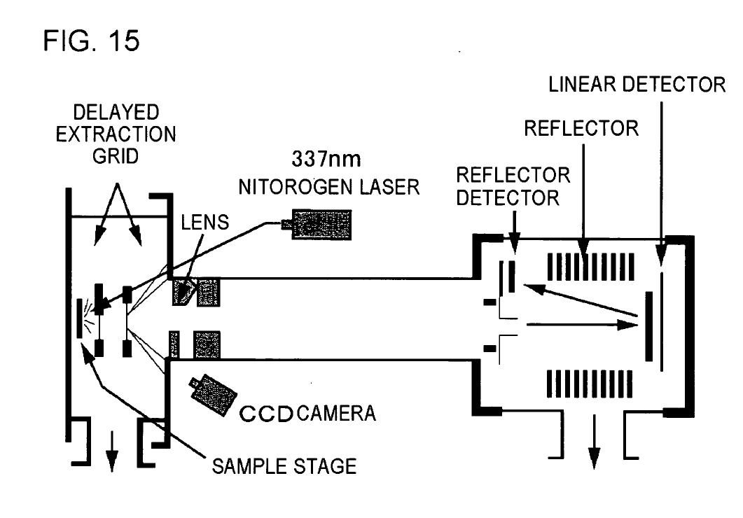

FIG. 15 schematically illustrates a configuration of the mass spectrometer. In FIG. 15, the dried sample is set on a sample stage. Then, the dried sample is irradiated with a nitrogen gas laser at a wavelength of 337 nm in vacuo, to vaporize the dried sample together with the matrix. By applying a voltage using the sample stage as an electrode, the vaporized sample travels in the vacuum atmosphere and detected by a detection unit comprising a reflector detector, a reflector and a linear detector.

Thus, using the microchip 121, the sample dried in the sucking portion 107 as the whole microchip 121 can be used in MALDI-TOFMS. Furthermore, for example, a sample separator may be placed upstream of the channel 103 to conduct extraction, drying and structural analysis of a target component on a single microchip. Such a microchip 121 may be useful in, for example, proteome analysis. Herein, since the microchip 121 is used as a chip for MALDI-TOFMS, a step of washing a sample reservoir in the MALDI-TOFMS for each sample can be eliminated, resulting in improvement in operational convenience and in measurement accuracy.

An MALDI-TOFMS matrix may be appropriately selected, depending on a material to be measured. Examples of a matrix which can be used include sinapic acid, α-CHCA (α-cyano-4-hydroxycinnamic acid), 2,5-DHB (2,5-dihydroxybenzoic acid), a mixture of 2,5-DHB and DHBs (5-methoxysalicylic acid), HABA (2-(hydroxyphenylazo) benzoic acid), 3-HPA (3-hydroxypicolinic acid), dithranol, THAP (2,4,6-trihydroxyacetophenone), IAA (trans-3-indoleacrylic acid), picolinic acid and nicotinic acid.

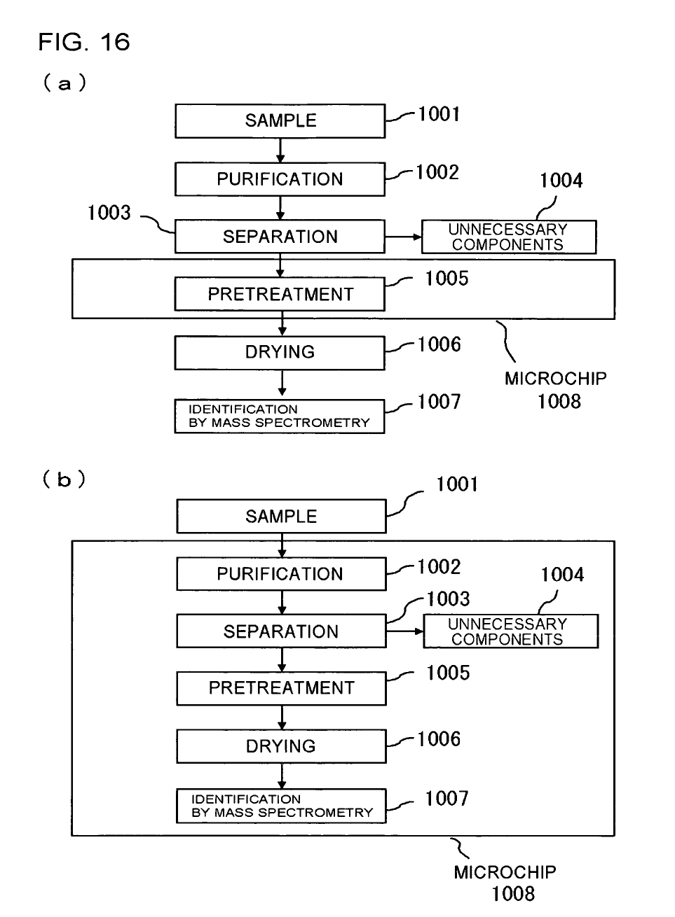

FIG. 16 is a block diagram of a mass spectrometry system comprising a drying device according to this embodiment. The system comprises purification means 1002 for removing impurities in a sample 1001 to some degree; separation means 1003 for removing undesired components 1004; pretreatment means 1005 for a separated sample; drying means 1006 for a sample after pretreatment; and identification means 1007 by mass spectrometry. The pretreatment 1005 effects molecular-weight reduction using, for example, trypsin, mixing with a matrix, and the like.

The microchip 121 in this embodiment corresponds to the microchip 1008, which can be used in the step of pretreatment 1005 as shown in FIG. 16(a). Furthermore, since the microchip 121 comprises a channel, the steps from purification 1002 to drying 1006 can be effected on a single microchip 1008 as shown in FIG. 16(b).

Thus, of the sample processing steps indicated in FIG. 16, any appropriately selected or all steps can be effected on the microchip 1008. By continuously processing a sample on the microchip 1008, even a trace amount of a component can be efficiently and reliably identified with a minimum loss.

(Third Embodiment)

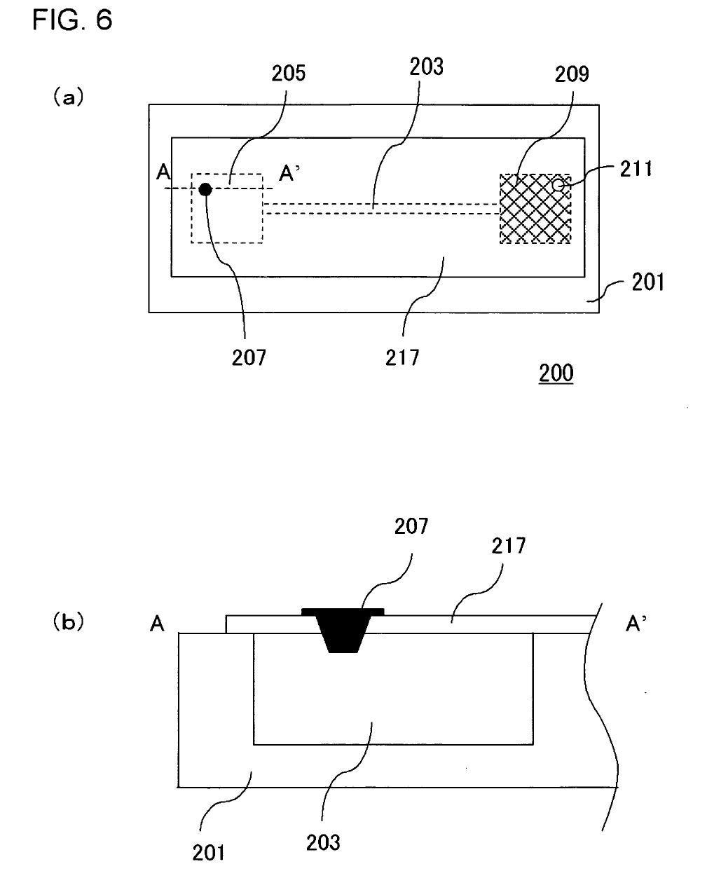

This embodiment relates to a microchip delivering a certain amount of a liquid to a given channel. FIG. 6 shows a configuration of a microchip 200 according to this embodiment. FIG. 6(a) is a top view of the microchip 200 and FIG. 6(b) is a cross-sectional view around a sample reservoir 205 taken on line A-A′.

In the microchip 200, which are on a substrate 101, a sample reservoir 205 and a water absorbing portion 209 are communicated via channel 203. Their upper surfaces are covered with a cover 217, whereby the sample reservoir 205 and the channel 203 are sealed. In addition, the sample reservoir 205 comprises a septum 207. When the septum 207 is closed, the sample reservoir 205 is sealed to retain a sample. When a septum 207 is removed or an air way is opened in the septum 207, a sample in the sample reservoir 205 is fed to the channel 203. Furthermore, the water absorbing portion 209 is comprised of a water-absorbing member for quickly absorbing a liquid in the channel 203 and is communicated with an outer atmosphere via an air hole 211.

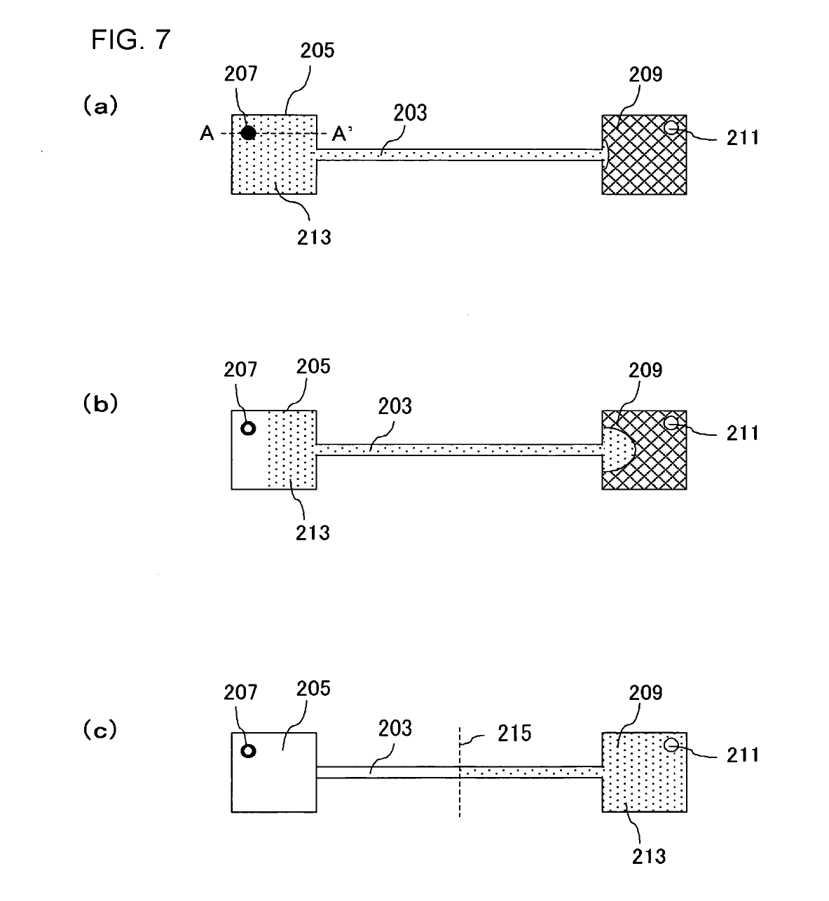

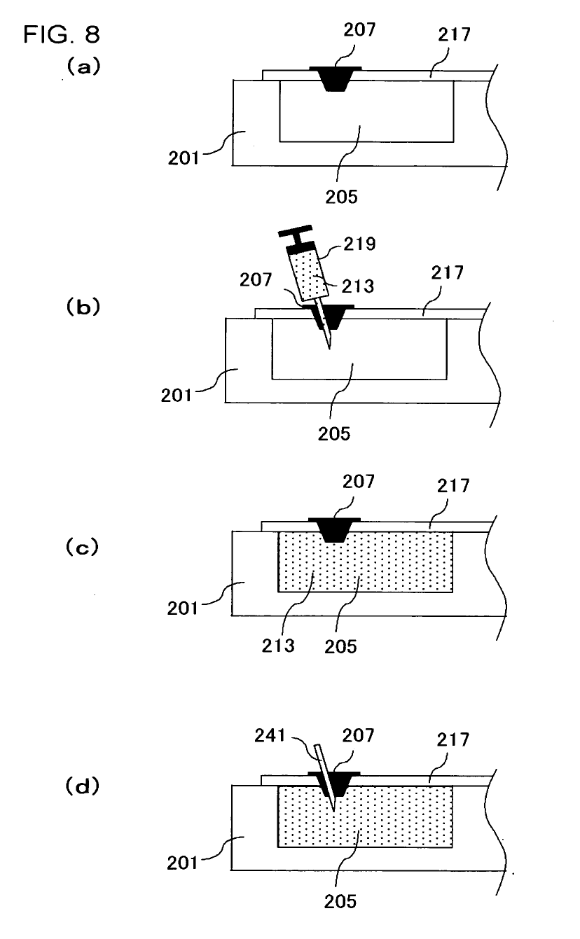

FIGS. 7 and 8 illustrate movement of a liquid in the microchip 200 in FIG. 6. FIG. 7 is a top view illustrating movement of a liquid in the microchip 200 and FIG. 8 shows the sample reservoir 205 in each step as in FIG. 6(b). There will be described the use of the microchip 200 with reference to FIGS. 7 and 8.

In FIG. 8(a), the sample reservoir 205 is not filled with a sample. A sample is, therefore, injected into the sample reservoir 205. The septum 207 is pierced by a syringe 219 filled with a sample 213 (FIG. 8(b)), and the sample 213 is injected into the sample reservoir 205. On drawing out the syringe 219, the sample reservoir 205 is sealed and the sample 213 is retained without flowing to the water absorbing portion 209 (FIGS. 8(c) and 7(a)). When an air hole is formed in the septum 207 in predetermined timing (FIG. 7(b)), the sample 213 in the sample reservoir 205 becomes in contact with the outer atmosphere via the air hole and the air hole 211 and then delivered to the water absorbing portion 209 (FIG. 7(c)). Herein, the air hole in the septum 207 can be formed by, for example, piercing the septum 207 by an injection needle 241. Alternatively, the septum 207 may be removed from the cover 217.

The amount of the sample 213 introduced into the water absorbing portion 209 can be controlled by the amount of the liquid retained in the sample reservoir 205 and the sample reaches a stop-line 215 in FIG. 7(c). Alternatively, the amount of the sample 213 introduced can be adjusted by sealing of the septum 207. Specifically, when the injection needle 241 piercing the septum 207 in FIG. 8(d) is drawn out in predetermined timing, liquid delivery is stopped.

As described above, in the microchip 200, the septum 207 acts as a switch member for delivery of the sample 213, allowing timing and the amount of liquid delivery to be suitably adjusted.

Constituent materials and a manufacturing process for the microchip 200 will be described. Materials for the substrate 101 and the cover 217 can be appropriately selected from those listed in the first embodiment. As in the sucking portion 107 in the microchip 100, the water absorbing portion 209 may be, for example, comprised of a number of pillars, a porous material filled therein, or a water-absorbing material filled therein. The septum 207 can be any material such as a rubber which can close a hole formed in the cover 217 and which can be pierced by an injection needle 241 and can again seal the septum immediately after drawing out the injection needle 241. Examples of a suitable material include materials having rubbery properties such as natural rubber, silicone resins, styrene thermoplastic elastomers (particularly, polystyrene-polyethylene/butylene-polystyrene: SEBS) and isoprene. Their surfaces may be coated by, for example, Teflon(trademark registrated). The microchip 200 may be manufactured by, for example, etching as described in the first embodiment.

In FIG. 6, the septum 207 may be a cover 217 covering the sample reservoir 205 or the sample reservoir 205 and the channel 203. For example, the whole cover 217 in FIG. 6 may be the septum 207. By covering the sample reservoir 205 and the channel 203 by the septum 207, injection and delivery of a sample can be controlled in a desired position in the channel 203 or the sample reservoir 205. Furthermore, since the steps of forming the cover 217 and inserting the septum 207 to it can be unnecessary, resulting in a further convenient manufacturing process.

(Fourth Embodiment)

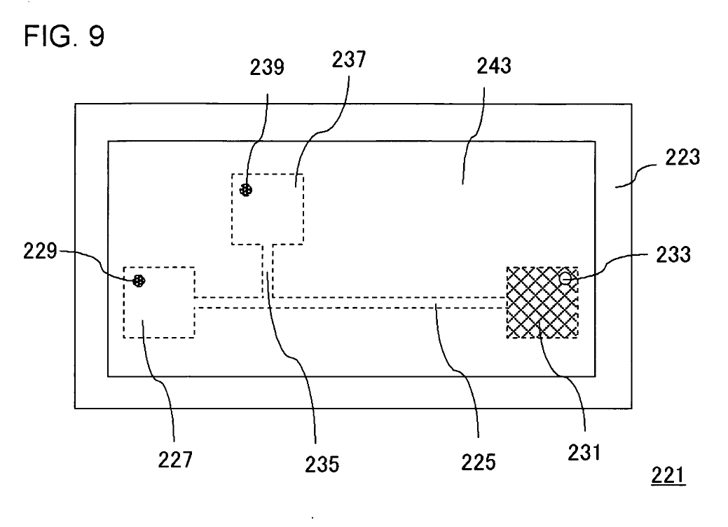

This embodiment relates to a microchip where a certain amount of a liquid is fed to a given channel and a reagent is introduced into the channel in predetermined timing. FIG. 9 is a top view illustrating a configuration of a microchip 221 according to this embodiment. In the microchip 221, on a substrate 223 are formed a sample reservoir 227 and a water absorbing portion 231, which are communicated via a main channel 225. At the end of a sub-channel 235 communicated with the main channel 225, a sample reservoir 237 is disposed. The surface of the substrate 223 is covered by a cover 243 while an air hole 233 is formed over the water absorbing portion 231. Air holes are also formed in the sample reservoir 227 and the sample reservoir 237 and are sealed by septums 229 and 239, respectively.

As described for Embodiment 3, a sample is introduced into the sample reservoir 227. The sample reservoir 237 is filled with a given reaction reagent. On forming a vent hole in the septum 229 by an injection needle, the sample flows in the main channel 225. At the time when the sample probably reaches the junction between the main channel 225 and the sub-channel 235, the septum 239 is also pierced by an injection needle to form a vent hole. Then, the reagent in the sample reservoir 237 is introduced into the main channel 225 from the sub-channel 235 and delivered to the water absorbing portion 231 while being mixed with the sample.

Thus, using the microchip 221, the sample can be subjected to a variety of reactions and processes. Herein, since the sample is mixed with the reagent added during flowing in the main channel 225, a mixing process can be unnecessary. Furthermore, in this system, the septums 229 and 239 can control initiation and stopping of liquid delivery, resulting in size reduction of an apparatus.

(Fifth Embodiment)

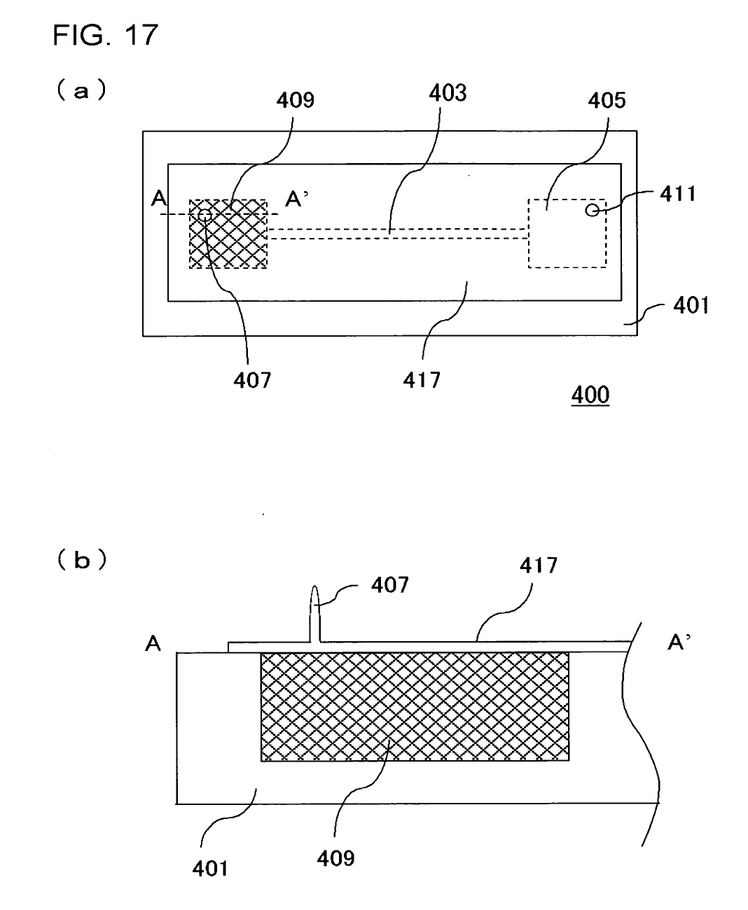

This embodiment relates to a microchip for delivering a certain amount of a liquid to a given channel. FIG. 17 is a top view illustrating a configuration of a microchip 400 according to this embodiment. FIG. 17(a) is a top view of the microchip 400 and FIG. 17(b) is a cross-sectional view taken on line A-A′ enlarging the area around a water absorbing portion 409.

In the microchip 400, a sample reservoir 405 and a water absorbing portion 409 formed in a substrate 401 are communicated via a channel 403. Their upper surfaces are covered by a cover 417 and the water absorbing portion 409 is sealed by the cover 417. Furthermore, in the water absorbing portion 409, a pin 407 is formed in the cover 417.

When the water absorbing portion 409 is sealed by the cover 417, the channel 403 is filled with the air, so that a liquid introduced into the sample reservoir 405 is retained in an area around the inlet of the channel 403 from the sample reservoir 405. When the pin 407 is broken, an opening is formed in the cover 417 so that the water absorbing portion 409 is communicated with the outer atmosphere. Therefore, on breaking the pin 407, a sample liquid in the sample reservoir 405 is fed to the channel 403. The water absorbing portion 409 is comprised of a packed water-absorbing member for rapidly absorbing a liquid in the channel 403, and the sample reservoir 405 has an air hole 411 for communication with the outer atmosphere.

The amount of the sample liquid introduced into the water absorbing portion 409 can be controlled by the amount of the liquid in the sample reservoir 405.

As described above, in the microchip 400 [symbol] , the pin 407 acts as a switch member for delivering a sample liquid, allowing timing and the amount of liquid delivery to be suitably adjusted.

The microchip 400 may be formed, for example, as described for the microchip 200 in the third embodiment. The constitutive material for the cover 417 may be any material having such hardness and elasticity that an opening can be formed on breaking the pin 407.

(Sixth Embodiment)

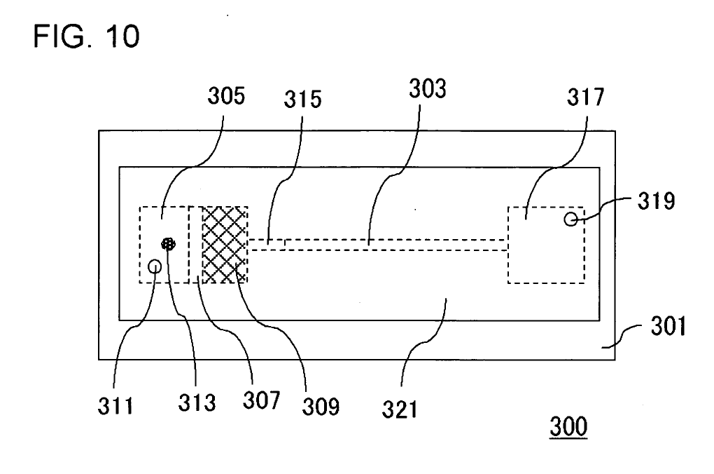

This embodiment relates to a microchip for delivering a certain amount of a liquid to a given channel under pressure. FIG. 10 is a top view illustrating a configuration of a microchip 300 according to this embodiment. In the microchip 300, a press-fed liquid reservoir 305 is formed on a substrate 301. Adjacent to the press-fed liquid reservoir 305, there are formed a first hydrophobic area 307, a water absorbing portion 309, a second hydrophobic area 315, and a channel 303 in sequence, and the other end of the channel 303 is communicated with a sample recovering portion 317. The upper surface of the substrate 301 is covered by the cover 321, and over the press-fed liquid reservoir 305 and the sample recovering portion 317 are formed an air holes 311 and 319, respectively. Furthermore, a magnet 313 is disposed within the press-fed liquid reservoir 305, and the magnet 313 is movable from, for example, the upper surface of the cover 321 or the bottom surface of the substrate 301 toward the first hydrophobic area 307 by a driving magnet (not shown).

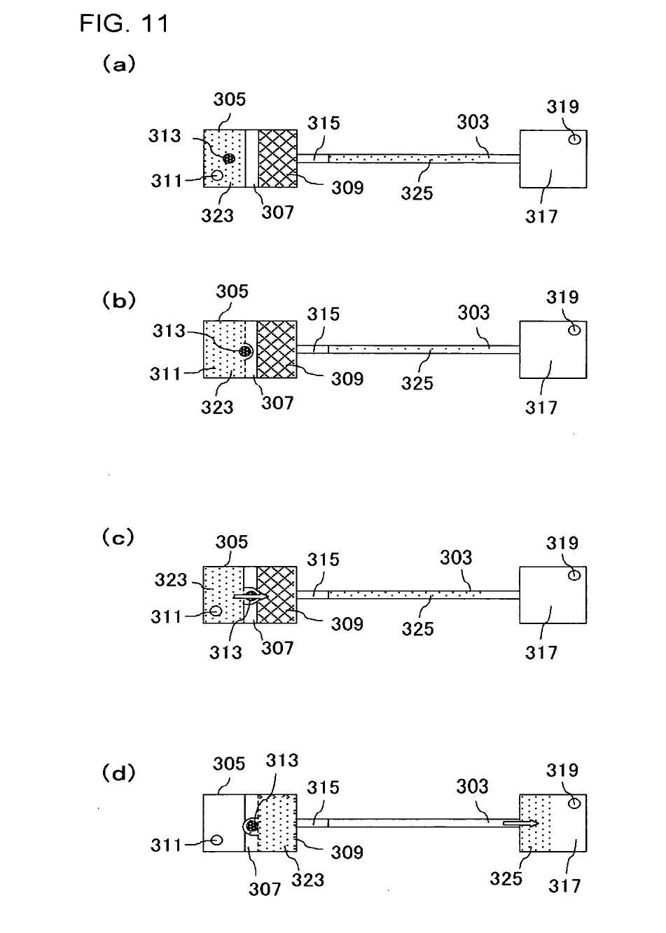

Using the magnet 313 as a switch member, the microchip 300 press-feeds a sample to the sample recovering portion 317 using a press-fed liquid in the press-fed liquid reservoir 305. This operation will be described with reference to FIG. 11. FIG. 11 illustrates operation of the microchip 300 in FIG. 10. The channel 303 actually comprises a variety of channel structures (not shown), and the sample 325 is in the channel 303 connecting the press-fed liquid reservoir 305 and the sample recovering portion 317. The press-fed liquid 323 fills from the air hole 311 to the press-fed liquid reservoir 305. Herein, the press-fed liquid reservoir 305 is adjacent to the first hydrophobic area 307, so that the liquid does not enter the first hydrophobic area 307, but is retained in the press-fed liquid reservoir 305. Furthermore, the magnet 313 is placed in the press-fed liquid reservoir 305 (for the above description, see FIG. 11(a)).

Next, for example, the driving magnet is moved on the upper surface of the cover 217 (FIG. 11(b)). Here, a small amount of the press-fed liquid 323 adhering the magnet 313 moves together with the magnet 313 from the press-fed liquid reservoir 305 to the first hydrophobic area 307. Then, at the time when the press-fed liquid 323 transferred with the magnet 313 reaches the first water absorbing portion 309 (FIG. 11(c)), the press-fed liquid 323 is instantly sucked into the water absorbing portion 309 by capillary action in the water absorbing portion 309. The suction force acts as a driving force to introduce the sample 325 in the channel 303 into the sample recovering portion 317 (FIG. 11(d)).

As described above, in the microchip 300, the magnet 313 acts as a switch member for delivering the sample 325, allowing timing and the amount of liquid delivery to be suitably adjusted. Here, since the second hydrophobic area 315 is formed in the channel 303, the sample 325 is not mixed with the press-fed liquid 323.

Next, there will be described constitutive components and a manufacturing process for the microchip 300. Materials for the substrate 301 and the cover 321 can be appropriately selected from those listed in the first embodiment. The water absorbing portion 309 may be, for example, comprised of a number of pillars formed therein, a porous material formed therein or a water-absorbing material formed therein. A water-absorbing material may be, for example, a material as described in the third embodiment. The driving magnet may be any magnet having sufficient strength and size to move the magnet 313. The magnet 313 may be any magnet having sufficient strength and size to be moved together with a small amount of the magnet 313 by the driving magnet, and may be one or a plurality of magnet beads, or alternatively a magnetic powder or magnetic particles. The surface of such a magnetic material is preferably hydrophilized. Hydrophilization of the surface allows water to preferably adhere to the surface during travelling, so that it can reliably act as a switch to be in contact with the water absorbing portion 309. The magnet may be metal particles, which can eliminate the necessity of hydrophlization and make a manufacturing process for the microchip 300 more convenient. Each member can be formed on the substrate 301, by, for example, etching as in the first embodiment. Furthermore, the first and the second hydrophobic areas 307 and 315 can be formed by hydrophobilization or water-repellent processing of the surface of the substrate 301.

The first and the second hydrophobic areas 307 and 315 can be formed by, for example, a combination of photolithography and a hydrophobic finishing agent or stamping with a highly hydrophobic rubber. In the former method, using a mask whereby an area to be hydrophobilized is exposed to a light, a photoresist is applied on a substrate, which is then exposed to a light and resist-developed to expose the substrate surface only in the area to be hydrophobilized. Then, the substrate is exposed to a vapor of the hydrophobic finishing agent such as hexamethyldisilazane, to form a hydrophobic film on the exposed surface of the substrate 301. Then, the resist is removed to prepare the substrate 301 where only the desired area is hydrophobic.

Stamping utilizes the feature that, for example, a highly hydrophobic rubbery material such as PDMS (polydimethylsiloxane) can be contacted with the substrate surface and peeled to form a hydrophobic surface only in the area in contact with the material. In advance, a PDMS stamp is formed, which has an irregular shape such that an area to be hydrophobilized becomes in contact with the substrate 301. After alignment, the stamp is contacted with the surface of the substrate 301. Then, the stamp can be peeled to give the substrate 301 where only the desired area is hydrophobic. Since PDMS is a soft rubbery material, it can contact with the inside of the channel groove slightly depressed from the surface. Thus, part of the inner surface of the channel 303 can be hydrophobilized. The PDMS stamp can be formed by first preparing a female template with an inverse irregular shape by etching an appropriate material such as silicon and a mold surrounding the template, pouring a mixed material of PDMS and a curing agent into the mold, polymerizing the material by heating and releasing it from the female template.

Although the magnet 313 has been used as a switch member for liquid delivery in the microchip 300, liquid delivery can be controlled as follows. For example, in the cover 321, a water-sucking hole may be formed at the position above the first hydrophobic area 307. In this configuration, when the press-fed liquid 323 is dropped to the water-sucking hole, the press-fed liquid reservoir 305 and the water absorbing portion 309 separated by the first hydrophobic area 307 are communicated by the press-fed liquid 323, so that the sample 325 is fed to the sample recovering portion 317 by the press-fed liquid 323 sucked into the water absorbing portion 309.

Alternatively, the microchip 300 may have a configuration where without the magnet 313, the press-fed liquid 323 in the press-fed liquid reservoir 305 can be contacted with the water absorbing portion 309 and then delivered by disposing a vibrator over the cover 321 or by vibrating it with, for example, a finger.

This invention has been described with reference to some embodiments. It will be understood by the skilled in the art that these embodiments are only illustrative and that there may be many variations for a combination of the components and the manufacturing process, which are encompassed by the present invention.

### (Example)

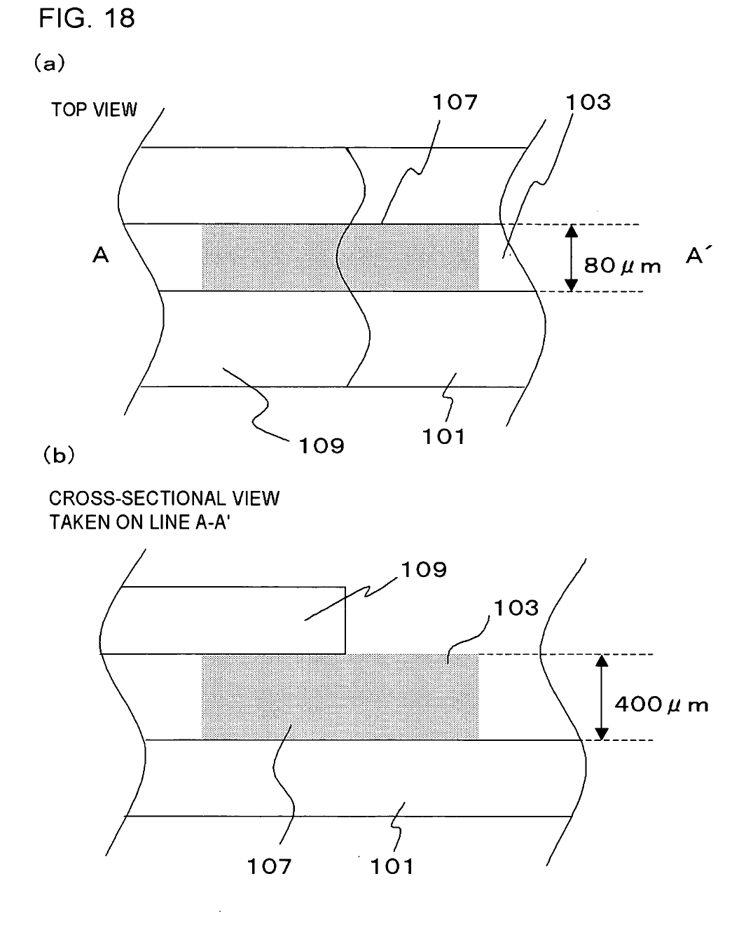

In this example, a drying device comprising the pillars described above with reference to FIG. 2 was fabricated on a substrate and evaluated. FIG. 18 schematically shows the drying device. FIG. 18(a) is a plan view of the drying device and FIG. 18(b) is a cross-sectional view taken on line A-A′ of FIG. 18(a).

In FIG. 18, a channel 103 is formed on a substrate 101 and a part of its upper surface is covered by a cover 109. The part with the cover 109 is upstream while that without the cover is downstream. A sucking portion 107 is formed in an outlet area in the channel 103, that is, the area upstream and downstream of the end of the cover 109. The sucking portion 107 comprises pillars 105.

In this example, the channel 103 and the pillar 105 were formed by the processing method described in the first embodiment. Silicon is used as the substrate. The channel 103 had a width of 80 μm and a depth of 400 nm.

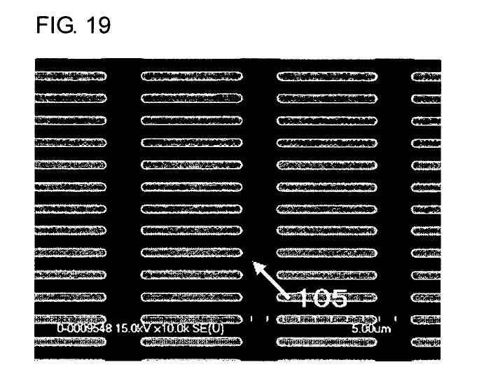

FIG. 19 is a drawing showing a scanning electron microscopic image of the pillar 105 formed in the outlet area in the channel 103. In FIG. 19 and FIGS. 20 and 21 described later, the upper direction from the paper is upstream and the lower direction is downstream. As shown in FIG. 19, the sucking portion of the drying device of this example comprises a plurality of strip-type pillars 105 with a width of 3 μm aligned with an equal pitch of about 1 μm in a longitudinal direction of the pillars 105 (a transverse direction in this figure), and multiple rows of the pillars 105 are disposed with an equal pitch of 700 nm in a lateral direction of the pillars 105 (a vertical direction in this figure). A height of the pillars 105 is 400 nm.

The microchip manufactured in this example was used to continuously conduct delivering and mass spectrometry of a DNA as described below. From the upstream of the channel 103, that is, from the opposite end to the sucking portion 107, water was introduced into the channel 103. The water filled the channel 103 and then leaked to the sucking portion 107 consisting of the pillars 105. Then, water was added dropwise to fully cover the sucking portion 107.

Subsequently, the upstream of the channel 103 was filled with a solution of a DNA (1300 bp) stained with a fluorescent dye. Then, the channel 102 was observed by fluorescence microscopy. Consequently, during the sucking portion 102 was fully covered by water, the DNA did not moved to the channel 102 at all. Then, after removing the water for exposing the sucking portion 102 to be naturally dried, the DNA began to move from the upstream of the channel 102 toward the downstream sucking portion 102, after which the water continuously flew in the channel 102. An average transfer rate of the DNA was 30 μm/s.

On the other hand, a microchip without the pillars in the outlet area of the channel 102 was prepared and observed as described above, giving an average transfer rate of the DNA was 8 μm/s. It was, therefore, demonstrated that forming the pillars 105 allowed the DNA to quickly travel in the channel 102. Furthermore, the DNA was moved by delivery of the DNA-containing solution.

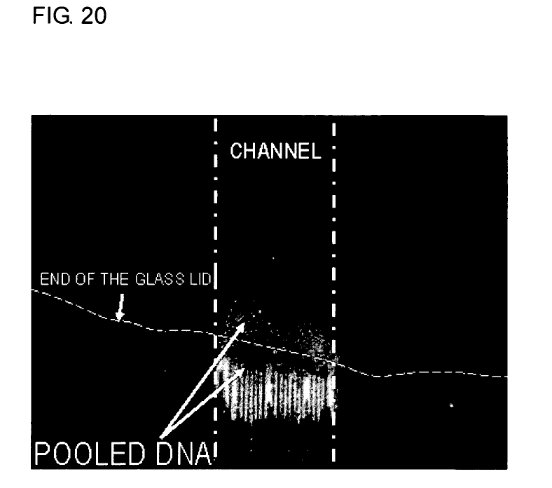

Next, after delivering a solution for about 30 min of a DNA (100p) stained with a fluorescent dye as described above, the sucking portion 107 was observed by fluorescence microscopy. FIG. 20 is a drawing showing a fluorescence microscopic image of the area around the pillars 105 formed in the sucking portion 107 in the outlet area of the channel 103. FIG. 20 shows that the DNA brightly highlighted by the fluorescent dye is exuded as a 60 μm band downstream of the cover 109. It confirms that the drying device of this example can be used to stably suck a sample into the sucking portion 107 as described with reference to FIG. 3(b).

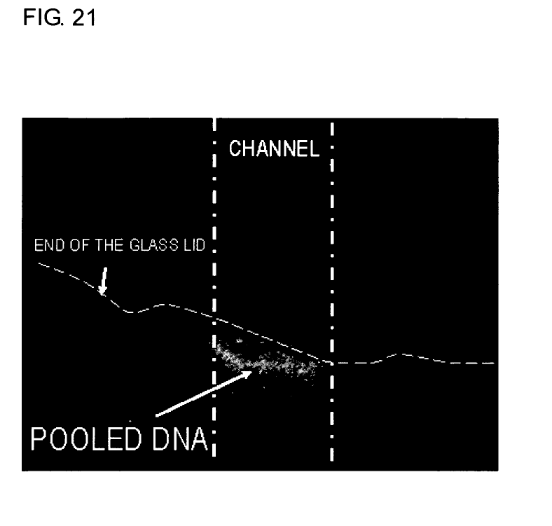

For comparison, observation was effected using the microchip without the pillars 105 in a similar manner. FIG. 21 is a drawing showing a fluorescence microgram for the microchip without pillars in the outlet area in the channel, in which DNA is not exuded outside of the cover 109. In the microchip without the pillars 105 where the depth of the channel 103 is 400 nm, it can be seen that a wetting degree described with reference to FIG. 3(a) is further reduced so that the sucking portion 107 is not wetted in the area from the edge of the cover 109 to the wall surface of the channel 103.

Then, the DNA dried using the drying device in FIG. 17 was analyzed by mass spectrometry. Specifically, the substrate 201 was sonicated on an ultrasonic vibrator to fragmentate the DNA and then the solvent was evaporated. Then, a several microliters of matrix was added dropwise to the dried DNA exuded in the outlet area in the channel 103 and the product was analyzed by MALDI-TOFMS. As a result, the analysis results from the DNA could be obtained.

As described above, in this example, the sucking portion 107 comprising a plurality of the pillars 105 at the end of the microchip channel 103 whose upper surface is at least partly opened was formed, so that the DNA could be moved to the sucking portion 107. Thus, a sucking portion 107 capable of controlling liquid delivery to the channel 103 was provided. Furthermore, the microchip could be used as a sample stage for a mass spectrometer and thus a drying device was provided, whereby sucking and mass spectrometry without removing the dried sample from the drying device could be conducted.

1. A microchip comprising a substrate, a channel formed on said substrate and a sample drying area having a fine channel communicated with said channel, wherein as a liquid in said sample drying area is evaporated, a liquid in said channel moves to said sample drying area.

2. A microchip comprising a substrate, a channel formed on said substrate and a sample drying area having a fine channel communicated with said channel, wherein during evaporation of said liquid in said sample drying area, said liquid is retained in said sample drying area and at the end of liquid evaporation, said liquid retained in said sample drying area moves toward said channel.

3. The microchip as claimed in claim 1 or 2, further comprising a temperature controlling member for controlling a temperature of said sample drying area.

4. A microchip comprising a substrate, a channel formed on said substrate, a sealed liquid retaining member communicated with said channel and a water absorbing portion communicated with said channel, wherein said liquid retaining member comprises a switch member for unsealing said liquid retaining member, wherein on unsealing, a liquid in said liquid retaining member moves to said water absorbing portion through said channel.

5. A microchip comprising a substrate, a channel formed on said substrate and a liquid retaining member communicated with said channel, wherein said liquid retaining member is sealed by a septum.

6. The microchip as claimed in claim 5, wherein the upper surface of said liquid retaining member is covered by a lid with a septum.

7. A microchip comprising a substrate, a channel formed on said substrate and a liquid retaining member communicated with said channel, wherein said liquid retaining member comprises a liquid retention area and a damming part intervening between said liquid retention area and said channel and comprising a lyophobic surface to said liquid; and in said liquid retaining member, a moving member comprising a lyophilic surface to said liquid is disposed movably from a position other than said damming part to said damming part.

8. The microchip as claimed in claim 7, wherein said liquid retaining member or said channel comprises a liquid-sucking portion communicated with said damming part and an air-introducing member communicated with said liquid-sucking portion.

9. A method for delivering a liquid in the microchip as claimed in any of claims 1 or 2, comprising:
introducing a liquid into said channel;
introducing a liquid into said sample drying area; and
evaporating said liquid introduced into said sample drying area while moving said liquid in said channel to said sample drying area.

10. A method for delivering a liquid in the microchip as claimed in claim 3, comprising:
introducing the liquid into said sample drying area;
evaporating said liquid introduced into said sample drying area; and
stopping evaporation of said liquid to move said liquid toward said channel.

11. A method for delivering a liquid in the microchip as claimed in claim 4, comprising:
introducing said liquid into said liquid retaining member; and
unsealing said liquid retaining member to move said liquid to said channel.

12. A method for delivering a liquid in the microchip as claimed in claim 5 or 6, comprising:
piercing said septum by an injection needle, through which said liquid is then introduced into said liquid retaining member;
pulling out said injection needle from said septum to reseal said liquid retaining member; and
piercing said septum by a hollow needle member to unseal said liquid retaining member for moving said liquid to said channel.

13. A method for delivering a liquid in the microchip as claimed in claim 8, comprising:
introducing said liquid into said liquid retaining member; and
moving said moving member to said damming part to introduce said liquid adhering to said moving member surface into said liquid-sucking portion.

14. The method for delivering a liquid as claimed in claim 13, wherein said step of moving said moving member to said damming part comprises said step of magnetically moving said moving member.

15. A mass spectrometry system comprising:
separation means for separating a biological sample according to a molecular size or properties;
pretreatment means for pretreating said sample separated by said separation means including enzymatic digestion;
drying means for drying said pretreated sample; and
mass spectrometry means for analyzing said dried sample by mass spectrometry,
wherein at least one of said separation means, said pretreatment means and said drying means comprises said microchip as claimed in any of claims 1, 2, 4, 5, 6, 7 or 8.

16. The microchip as claimed in any of claims 1 or 2, wherein said sample drying area comprises a plurality of pillars.

17. The microchip as claimed in any of claims 1 or 2, wherein
said sample drying area is filled with a water-absorbing material.

18. The microchip as claimed in any of claims 1 or 2, wherein said sample drying area comprises a porous material.

19. The microchip as claimed in any of claims 1 or 2, wherein said sample drying area comprises a plurality of concaves.

20. A mass spectrometry system comprising separation means for separating a biological sample according to a molecular size or properties;
pre-treatment means for pretreating said sample separated by said separation means including enzymatic digestion;
drying means for drying said pretreated sample; and
mass spectrometry means for analyzing said dried sample by mass spectrometry,
wherein at least one of said separation means, said pre-treatment means and said drying means comprises said microchip as claimed in claim 16.

21. A mass spectrometry system comprising
separation means for separating a biological sample according to a molecular size or properties;
pre-treatment means for pretreating said sample separated by said separation means including enzymatic digestion;
drying means for drying said pretreated sample; and
mass spectrometry means for analyzing said dried sample by mass spectrometry,
wherein at least one of said separation means, said pre-treatment means and said drying means comprises said microchip as claimed in claim 17.

22. A mass spectrometry system comprising
separation means for separating a biological sample according to a molecular size or properties;
pre-treatment means for pretreating said sample separated by said separation means including enzymatic digestion;
drying means for drying said pretreated sample; and
mass spectrometry means for analyzing said dried sample by mass spectrometry,
wherein at least one of said separation means, said pre-treatment means and said drying means comprises said microchip as claimed in claim 18.

23. A mass spectrometry system comprising
separation means for separating a biological sample according to a molecular size or properties;
pre-treatment means for pretreating said sample separated by said separation means including enzymatic digestion;
drying means for drying said pretreated sample; and
mass spectrometry means for analyzing said dried sample by mass spectrometry,
wherein at least one of said separation means, said pre-treatment means and said drying means comprises said microchip as claimed in claim 19.
